(19) United States
(12) Patent Application Publication
(10) Pub. No.: US 2006/0290122 A1
(43) Pub. Date: Dec. 28, 2006

(54) Integrated tether for rollover airbags

(75) Inventor: Mark C. Woydick, Lake Orion, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/159,370

(22) Filed: Jun. 23, 2005

(51) Int. Cl. B60R 21/213; B60R 21/23

(52) U.S. Cl. 280/743.2; 280/730.2

(57) ABSTRACT

A side airbag assembly for protecting an occupant in a vehicle includes an airbag formed from a single fabric panel and a tether with a first end and a second end. The tether is integrally formed with the airbag from the same fabric panel. The first end of the tether is the integral joint between the airbag and tether. The second end of the tether connects to a component of a vehicle. The tether can be folded over and sewn together to fix the position of the tether relative to the airbag or the tether can be integrally woven to the airbag.

### BACKGROUND

The present invention relates generally to the field of airbags. More specifically, this invention relates to airbags for rollover and first-impact applications that include tethers.

Conventional airbags generally use tethers sewn to the main airbag cushion. The tethers help ensure containment of an occupant by the airbag. The tethers also help keep the airbag cushion in the desired vertical and horizontal deployed positions relative to a vehicle's interior geometry. The conventional tethers are generally separate items that are sewn to the airbag cushion.

Another conventional mechanism for maintaining the proper position of an airbag is a sail panel. Conventionally, sail panels are un-inflated extensions of the airbag cushion.

### SUMMARY

One embodiment of the invention relates to an airbag for protecting an occupant in a vehicle. The airbag comprises a tether with a first end and a second end, and being integrally formed with the airbag. The first end is the integral joint between the airbag and tether, and the second end connects to a vehicle pillar. The tether is configured to move downward during inflation of the airbag along a longitudinal length of the vehicle pillar.

Another embodiment of the invention relates to an airbag for protecting an occupant in a vehicle. The airbag comprises a tether integrally formed with the airbag, the tether being integrally joined at a first end to the airbag and being connected to a component of the vehicle at a second end. The airbag is positioned along a roofline of the vehicle.

Another aspect of the invention relates to a side airbag for protecting an occupant in a vehicle. The side airbag comprises a tether with a first end and a second end, and being integrally formed with the airbag. The first end includes a fold and a sewn seam configured to position the tether in relation to the airbag. The airbag is formed by a one-piece woven material.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a view of an airbag with an integrated tether connected to a vehicle pillar according to an embodiment of the present invention.

FIG. 2 is a view of a fabric panel of the airbag shown in FIG. 1.

FIG. 3 is a view of the fabric panel showing fold lines for the tether shown in FIG. 1.

FIG. 4 is a view of an airbag with an integrated tether connected to a vehicle pillar according to another embodiment of the present invention.

FIG. 5 is a view of a fabric panel of the airbag shown in FIG. 3.

FIG. 6 is a view of an airbag with an integrated tether according to another embodiment of the present invention.

FIG. 7 is a view of an airbag with an integrated tether with a connecting clamp according to an embodiment of the present invention.

### DETAILED DESCRIPTION

Hereinafter, embodiments of the present invention will be described with reference to the attached drawings.

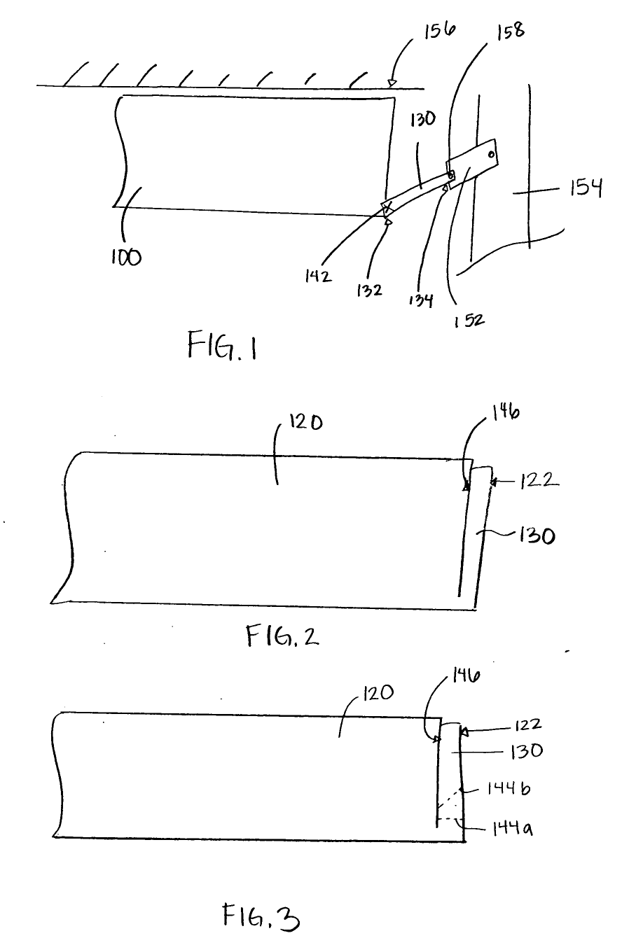

FIGS. 1-3 show an embodiment of an airbag assembly for protecting an occupant in a vehicle. The airbag assembly includes an airbag 100 with an integral tether 130. The airbag 100 and tether 130 are formed from one piece of fabric panel 120.

The airbag 100 can be a side-mounted airbag to protect an occupant's head. The airbag 100 can be positioned along the roof line 156 of a vehicle, such that the airbag 100 extends, upon inflation, between a vehicle occupant and a vehicle window. Such airbags 100 are considered to be “first impact” or rollover protection airbags. However, the airbag 100 can be mounted in a door, in a steering wheel, in the headliner, or any other suitable location for protecting a vehicle occupant during a rollover situation.

The airbag 100 can be inflated by a gas generator (not shown). Upon inflation, the airbag 100 can extend downward from the roof line of the vehicle and longitudinally along the length of a vehicle pillar 154. The tether 130 includes a first end 132 and a second end 134. The first end 132 of the tether 130 is the integral joint between the airbag 100 and the tether 130. The second end 134 connects to a component of a vehicle. The tether 130 is the connection between the airbag 100 and a component of the vehicle, such as a guide 152 or a vehicle pillar 154. The guide 152 travels longitudinally along the length of the vehicle pillar 154 during inflation of the airbag 100. The tether 130 is integrally attached at a first end 132 to the airbag 100 and is connected to the guide 152 by a sewn seam, loop, or other suitable mechanism. The tether 130 helps maintain the proper alignment of the airbag 100 during inflation. The tether 130 is configured to move downward during inflation of the airbag 100 along the longitudinal length of the vehicle pillar 154, thus moving a lower portion of the airbag 100 downward.

FIG. 1 shows the tether 130 positioned in the rear (side farther from a windshield of the vehicle) of the airbag 10. The airbag 100 can also include a plurality of tethers 130. The tethers 130 can be positioned in the front, rear or both the front and rear positions of the airbag 100.

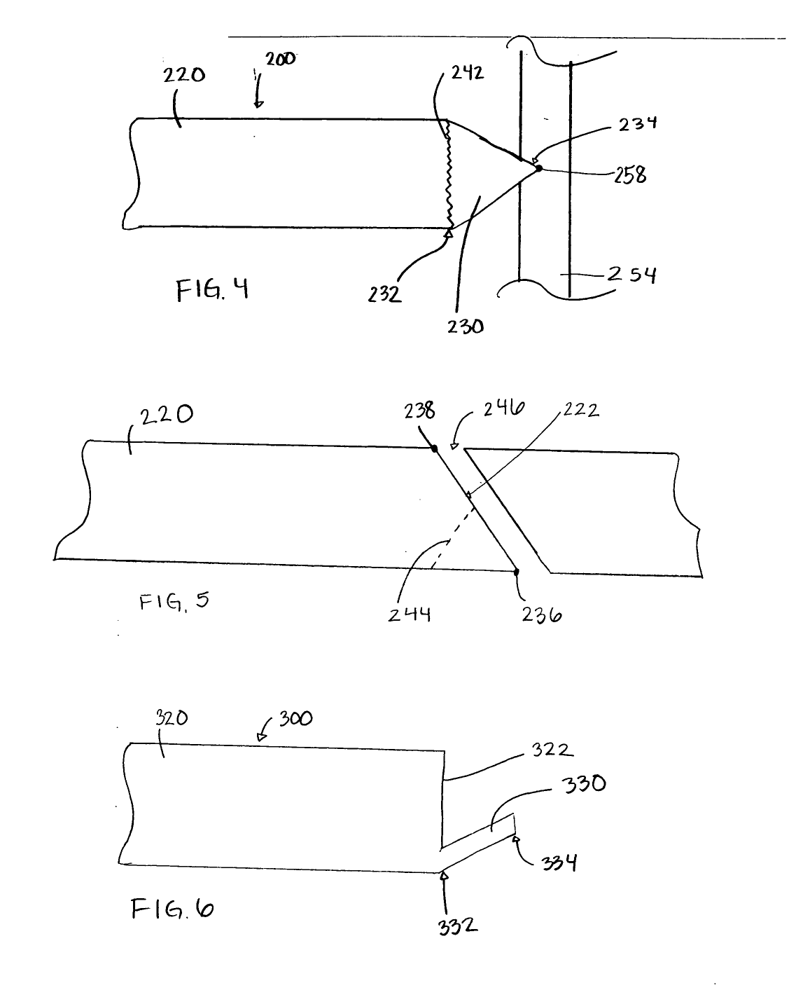

The airbag 100 and tether 130 are formed integrally from a single fabric panel 120. The fabric panel 120 is cut, along cut line 146, to separate a portion of the tether 130 from the airbag 100. This cut line 146 extends from a top portion of the fabric panel 120 towards a bottom portion of the fabric panel 120. The cut line 146 ends before reaching the bottom portion of the fabric panel 120, leaving a first end 132 of the tether 130 joined with the remainder of the fabric panel 120. As shown in FIGS. 2 and 3, the tether 130 is cut from an outer edge 122 of the fabric panel 120. Positioning the cut line 146 near the outer edge 122 maximizes material utilization of the fabric panel 120. The tether 130 is then folded and sewn to position the tether 130 in the proper tether orientation.

FIG. 3 shows an exemplary folding process for the tether 30. After the fabric panel 120 is cut along cut line 146, a first portion of the tether 130 is folded over a second portion of the tether 130. For example, the tether 130 is folded backward along fold line 144a. Next, the tether 130 is folded again, along fold line 144b, to position the tether 130 in the proper orientation for attaching to the vehicle and/or guide 152. The fold lines 144a, 144b are exemplary only. Any other suitable folding process can be used to position the tether 130. After folding, the first and second portions of the tether 130 are sewn together at sewn seam 142 to fix the position of the tether 130 relative to the airbag 100.

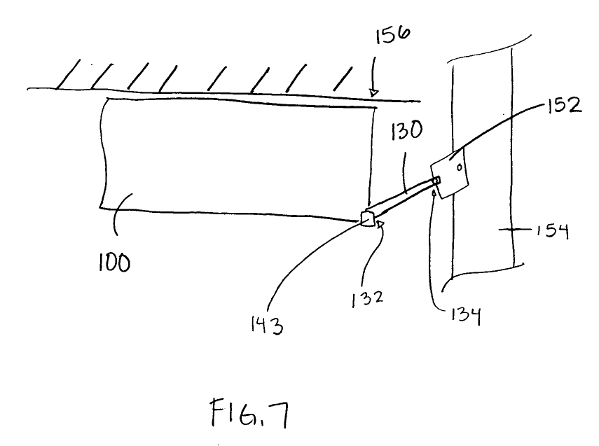

FIGS. 4 and 5 illustrate another embodiment of an airbag assembly for protecting an occupant in a vehicle. The airbag assembly includes an airbag 200 with an integral tether 230. The airbag 200 and tether 230 are formed integrally from one piece of fabric panel 220.

The airbag 200 and tether 230 are formed from a single piece of fabric panel 220. The fabric panel 220 is cut along a cut line 246 to cut an outer edge 222 of the fabric panel 220 into the proper shape for forming the tether 230. The cut line 246 forms a triangular section at an end of the fabric panel 220. This triangular section forms the tether 230. A first portion of the tether 230 is folded over a second portion of the tether 230 such that a first point 236 is aligned with a second point 238. Aligning the first 236 and second 238 points folds the tether along fold line 244. This fold line 244 creates a triangular shape for the tether 230, as can be seen in FIG. 4. After the first portion is folded over the second portion of the tether 230, the first and second portions are sewn together along sewn seam 242, to fix the position of the tether 230 relative to the airbag 200.

The tether 230 then extends from a first end 232 and a second end 234. The first end is the integral joint between the tether 230 and the airbag 200. The second end 234 connects to a component of the vehicle, such as a guide or a vehicle pillar 234. The component may be any other suitable portion of the vehicle.

According to another embodiment shown in FIG. 6, an airbag assembly for protecting an occupant in a vehicle is shown. The airbag assembly includes an airbag 300 with an integral tether 330. The airbag 300 and tether 330 are formed integrally of a one-piece woven material 320.

When the airbag 300 is woven, the tether 330 can be woven integrally with the airbag 300. The weaving process would not require a cut line to separate the tether 330 from the airbag 300; rather the tether 330 is directly woven to the airbag 300 in a fixed position relative to the airbag 300.

The tether 330 juts out from an outer edge 322 of the one-piece woven material 320. The tether 330 includes a first end 332 and a second end 334. The first end 332 is the integral joint between the airbag 300 and the tether 330. The second end 334 connects to a component of the vehicle, such as a vehicle pillar or guide.

The one-piece woven material 320 can be made on a Jacquard loom. The airbag 300 is woven directly off the loom in a single process and is a seamless, non-stitched type of airbag 300. The airbag 300 can be formed by an inflatable pocket formed in the one-piece woven material 320. The tether 330 is an extension of the one-piece woven material 320.

According to other embodiments of the present invention, the fabric panel 120 can be cut along any outer edge to separate the tether 130 from the airbag 100. The cut line 146 does not have to extend from top to bottom in the fabric panel 120, but can extend sideways or in any direction. Further, the tether 130 can be affixed to the fabric panel 120 and airbag 100 by any suitable mechanism. For example, the tether 130 can be sewn onto the fabric panel 120 to affix the tether 130 in a desired orientation. In another embodiment, as can be seen in FIG. 7, the tether 130 can be affixed by a metal or plastic clamp or clip. The clamp 143 can include teeth to clamp onto the tether 130 and fabric panel 120.

It will be recognized that any combination of embodiments, or elements from various embodiments, may be used in another embodiment of the present invention.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag for protecting an occupant in a vehicle, comprising:
a tether with a first end and a second end, and being integrally formed with the airbag,
wherein the first end is the integral joint between the airbag and tether, and the second end connects to a vehicle pillar, and
wherein the tether is configured to move downward during inflation of the airbag along a longitudinal length of the vehicle pillar.

2. The airbag of claim 1, further comprising a guide attached at one end to the tether and a second end of the guide being attached to the vehicle pillar, the guide being configured to move the tether along a longitudinal length of the vehicle pillar during inflation of the airbag.

3. The airbag of claim 1, wherein the airbag includes a fabric panel that is cut along a cut line to separate a portion of the tether from the airbag.

4. The airbag of claim 3, wherein the tether is formed along an outer edge portion of the fabric panel.

5. The airbag of claim 4, wherein a first portion of the tether is folded over a second portion of the tether, the first portion and second portion being sewn together to fix the position of the tether relative to the airbag.

6. The airbag of claim 4, wherein a first portion of the tether is folded over a second portion of the tether, the first portion and second portion being attached by a clamp to fix the position of the tether relative to the airbag.

7. The airbag of claim 1, wherein the airbag and tether are formed of a woven fabric panel and the tether is woven directly to the airbag.

8. The airbag of claim 7, wherein the woven fabric panel comprises a one-piece woven material.

9. An airbag for protecting an occupant in a vehicle, comprising:
a tether integrally formed with the airbag, the tether being integrally joined at a first end to the airbag and being connected to a component of the vehicle at a second end,
wherein the airbag is positioned along a roofline of the vehicle.

10. The airbag of claim 9, wherein the component includes a guide; the guide being attached at one end to the tether and a second end of the guide being attached to a vehicle pillar, the guide being configured to move the tether along a longitudinal length of the vehicle pillar during inflation of the airbag.

11. The airbag of claim 9, wherein the airbag includes a fabric panel that is cut along a cut line to separate a portion of the tether from the airbag.

12. The airbag of claim 11, wherein the tether is formed along an outer edge portion of the fabric panel.

13. The airbag of claim 12, wherein a first portion of the tether is folded over a second portion of the tether, the first portion and second portion being sewn together to fix the position of the tether relative to the airbag.

14. The airbag of claim 12, wherein a first portion of the tether is folded over a second portion of the tether, the first portion and second portion being attached by a clamp to fix the position of the tether relative to the airbag.

15. The airbag of claim 9, wherein the airbag and tether are formed of a woven fabric panel and the tether is woven directly to the airbag.

16. The airbag of claim 15, wherein the woven fabric panel comprises a one-piece woven material.

17. A side airbag for protecting an occupant in a vehicle, comprising:
a tether with a first end and a second end, and being integrally formed with the airbag,
wherein the first end includes a fold and a sewn seam configured to position the tether in relation to the airbag, and
wherein the airbag is formed by a one-piece woven material.

18. The side airbag of claim 17, further comprising a guide attached at one end to the tether and a second end of the guide being attached to a vehicle pillar, the guide being configured to move the tether along a longitudinal length of the vehicle pillar during inflation of the airbag.

19. The side airbag of claim 17, wherein the one-piece woven material is cut along a cut line to separate a portion of the tether from the airbag.

20. The side airbag of claim 17, wherein the tether is formed along an outer edge portion of the one-piece woven material.

21. The side airbag of claim 18, wherein a first portion of the tether is folded over a second portion of the tether, the first portion and second portion being sewn together to fix the position of the tether relative to the airbag.

22. The side airbag of claim 18, wherein a first portion of the tether is folded over a second portion of the tether, the first portion and second portion being attached by a clamp to fix the position of the tether relative to the airbag.
